(19) United States
(12) Patent Application Publication
(10) Pub. No.: US 2016/0286136 A1
(43) Pub. Date: Sep. 29, 2016

(54) Dual Camera Device for Hunting

(71) Applicants: Engineering Nto Moo Vang, Clements, MN (US); Kay Vang, Clements, MN (US)

(72) Inventors: Engineering Nto Moo Vang, Clements, MN (US); Kay Vang, Clements, MN (US)

(21) Appl. No.: 15/081,797

(22) Filed: Mar. 25, 2016

Related U.S. Application Data
(60) Provisional application No. 62/138,202, filed on Mar. 25, 2015.

(51) Int. Cl. H04N 5/247; H04N 5/232; H04N 5/225

(52) U.S. Cl. CPC H04N 5/247; H04N 5/2252; H04N 5/23293; H04N 5/23203

(57) ABSTRACT

A device to be used when hunting contains a primary camera, a secondary camera, a display screen, a processing unit, a control unit, a memory storage device, and a main body. The primary camera is used to record and capture information regarding a target. The secondary camera is used to record and capture information regarding the hunter. The user can view information received from the primary camera through the display screen. A waterproof housing is used to protect the device from external impacts. For increased efficiency, a motion detector unit and a range detector unit is included. Moreover, a night vision unit is included to aid with hunting in low light conditions. For navigating purposes, a global positioning system device is also included.

The current application claims a priority to the U.S. Provisional Patent application Ser. No. 62/138,202 filed on Mar. 25, 2015.

### FIELD OF THE INVENTION

The present invention relates generally to hunting accessories. More specifically, the present invention is a device used for viewing and accurately shooting an animal for recreation or sport. In addition to recording and viewing the game, the present invention also allows the hunter to record themselves during the hunting process.

### BACKGROUND OF THE INVENTION

Most hunters prefer to record the hunting process. However, the lack of proper cameras that can be used with a hunting device and the extra weight added by the existing hunting cameras, discourage the hunter to use the existing cameras. Since recording the hunting process allows the hunter reevaluate the hunt at a later time, the recording can be used for perfecting the hunting process in the future.

In addition to recording the target, most hunters also prefer to record themselves during the hunting process. The recorded information can be used to for self-improvement purposes or for future reference. However, since most existing cameras only focus on the prey the ability to record the hunter is limited. Even though a second camera can be used in addition to the front-facing camera, the need to control the second camera while hunting can distract the hunter.

Depending on the difficulty of the terrain and other similar factors, hunting may be executed by multiple hunters. When multiple hunters are present, the need to communicate with each other is essential so that the hunters are aware of the whereabouts of each hunter of the group. Even though mobile phones can be used to communicate with each other in an open terrain, the use of mobile phones can be limited with denser terrains resulting in poor cellular network availability. Finding directions for navigating through dense terrains can also be difficult with limited cellular network availability.

Accuracy is a vital aspect during hunting. A shot which is off target can result in losing the target, or in dangerous situations for the hunter. As of now, most hunting accessories are not focused on improving the accuracy of the shooter. In other words, most existing accessories assist the shooting process but the accuracy of a shot mainly depends on the skills of the shooter. Therefore, the need for a method that can be used to accurately shoot a target is clearly evident.

The objective of the present invention is to address the aforementioned issues. In particular, the present invention introduces a device used during hunting with a front facing camera and a rear facing camera. In addition to the ability to view the prey and the hunter, the present invention also helps the hunter shoot more accurately. The effective design and build, allows the user to utilize the present invention along with regular hunting gear such as guns.

### BRIEF DESCRIPTION OF THE DRAWINGS

FIG. 1 is a perspective view of the present invention.

FIG. 2 is a perspective view of the present invention, wherein the waterproof housing is used.

FIG. 3 is a rear perspective view of the present invention.

FIG. 4 is a top view of the present invention.

FIG. 5 is a rear perspective view of the present invention, wherein the waterproof housing is used.

FIG. 6 is a system overview of the present invention.

FIG. 7 is an illustration of using the range detector unit and the motion detector unit.

FIG. 8 is an illustration of using the night vision unit.

FIG. 9 is an illustration of using the global positioning system device.

FIG. 10 is an illustration of using the wireless data transfer unit.

FIG. 11 is an illustration of using the microphone and the speaker.

FIG. 12 is an illustration of using the view finder unit.

FIG. 13 is an illustration of the power source being electronically connected to the processing unit.

FIG. 14 is an illustration of wirelessly controlling the present invention.

### DETAIL DESCRIPTIONS OF THE INVENTION

All illustrations of the drawings are for the purpose of describing selected versions of the present invention and are not intended to limit the scope of the present invention.

The present invention introduces a device that can be used during hunting. More specifically, the present invention is intended to be used along with a gun or similar device that is being used for hunting. By utilizing the present invention, the hunter is guaranteed to shoot accurately. Moreover, the present invention also allows the hunter to record the hunting process such that the hunter can use the footage for future reference.

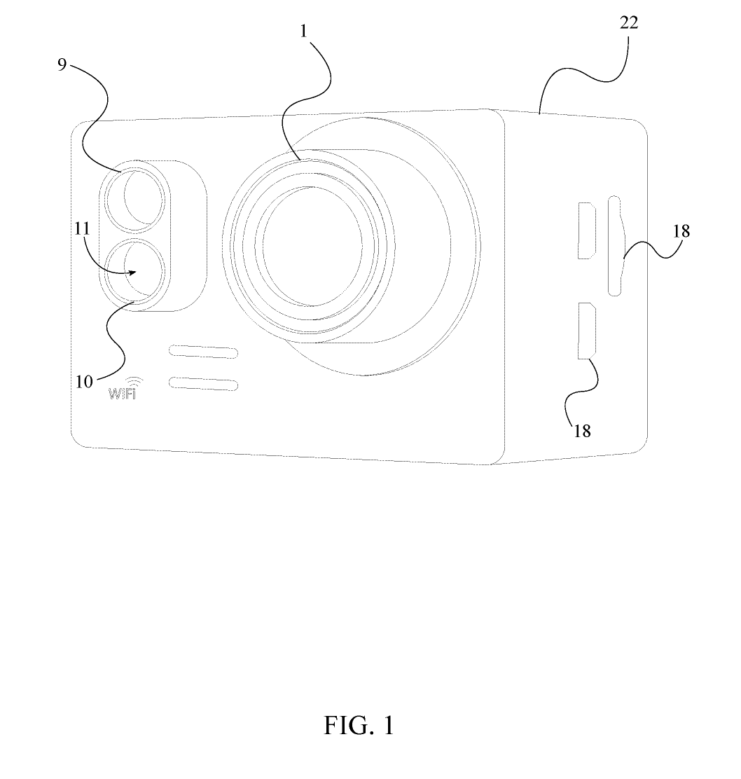

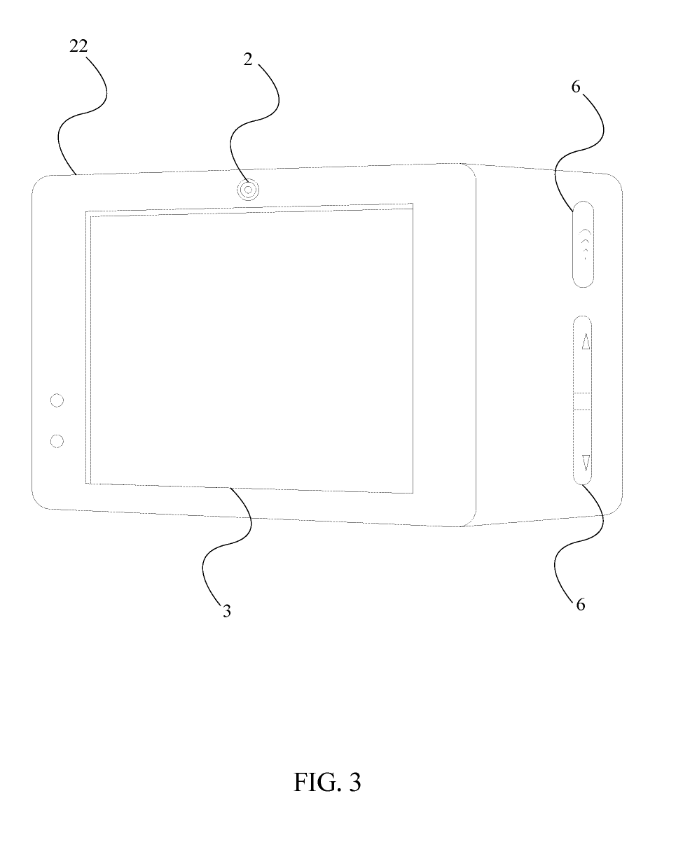

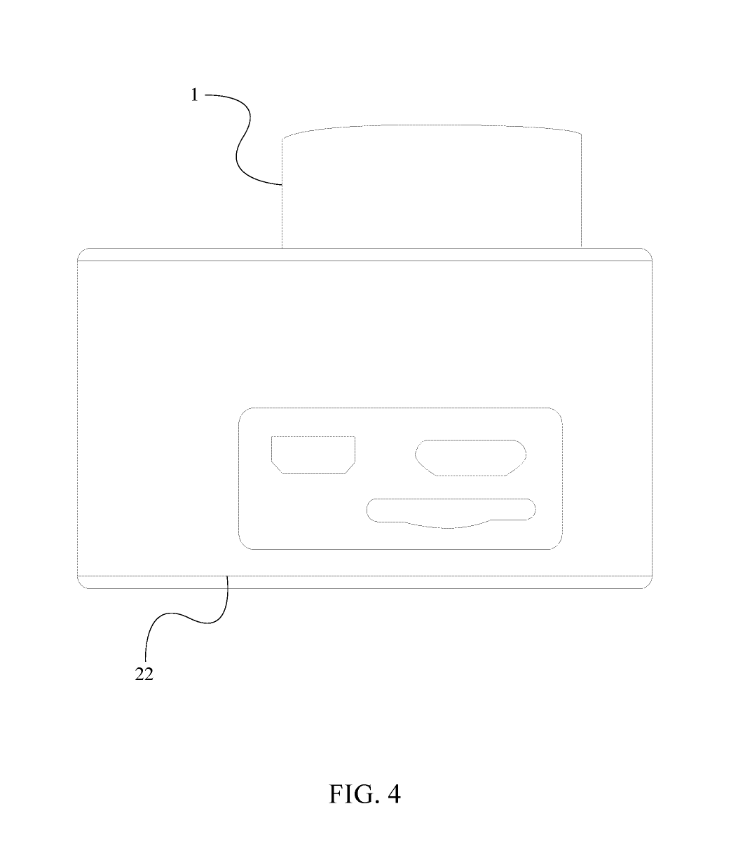

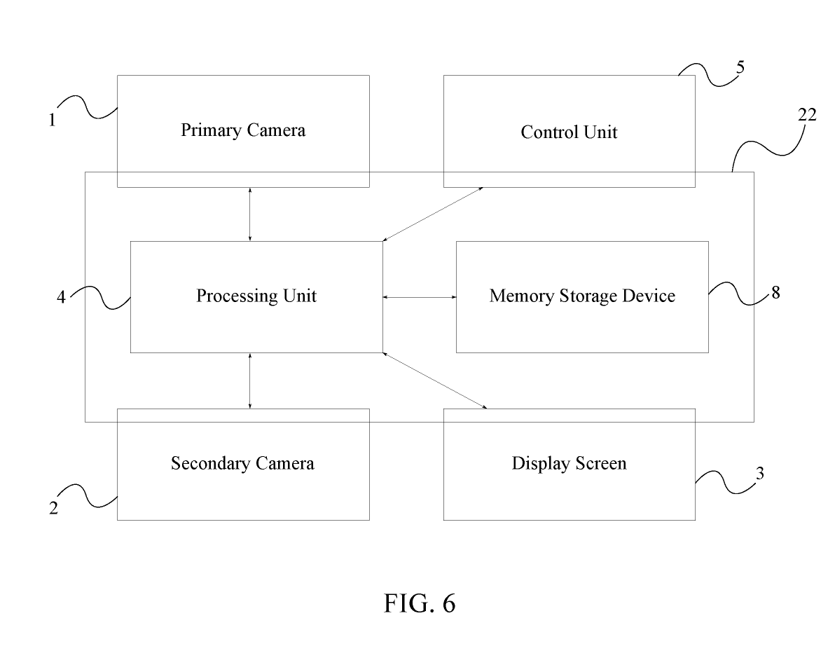

The effective design of the present invention allows to record the hunting process and also record the hunter while engaged the hunting process. As seen in FIGS. 1-6, in order to complete the recording process and other hunting related aspects, the present invention comprises a primary camera 1, a secondary camera 2, a display screen 3, a processing unit 4, a control unit 5, a memory storage device 8, and a main body 22. In order to maintain a compact structure, the primary camera 1, the secondary camera 2, and the display screen 3 are mounted into the main body 22. The main body 22 is designed from durable yet lightweight material. The primary camera 1 and the secondary camera 2 are used for recording purposes and can vary in size, quality, and shape in different embodiments of the present invention. In particular, the primary camera 1 is used for recording the target and the vicinity of the target. On the other hand, the secondary camera 2 is used to record the hunter during the hunting process. In order to do so, the primary camera 1 is positioned opposite the secondary camera 2 across the main body 22. The user and the target can be simultaneously recorded due to the positioning of the primary camera 1 and the secondary camera 2. More specifically, the primary camera 1 and the secondary camera 2 are oriented in opposing directions allowing simultaneous recording of the target and the hunter. In addition to recording, the primary camera 1 and the secondary camera 2 can also be used to capture still photographs. The processing unit 4 manages all data of the present invention. In order to do so, the primary camera 1, the secondary camera 2, the control unit 5, the display screen 3, and the memory storage device 8 are electronically connected to the processing unit 4. The control unit 5 allows the user to manage all controls of the present invention. In order to do so, the control unit 5 comprises a plurality of controls 6 which is integrated into the main body 22. As an example, if the user intends on managing the primary camera 1 or the secondary camera 2, the control unit 5 can be used since the control unit 5 is electronically connected to the processing unit 4. The display screen 3 is used to view the imagery received from the primary camera 1 and the secondary camera 2. Moreover, the display screen 3 is also used to display details that help the hunter shoot more accurately. In order to display the information to the user, the display screen 3 is positioned opposite the primary camera 1 and across the main body 22. In the preferred embodiment of the present invention, the display screen 3 is a touch-sensitive screen. However, the display screen 3 can vary in different embodiments of the present invention. As an example, the display screen 3 can be split to simultaneously display imagery from both the primary camera 1 and the secondary camera 2. When data is captured from the primary camera 1 and the secondary camera 2, the data is transferred to the memory storage device 8 through the processing unit 4 allowing the user to extract the data whenever the need arises. Both the processing unit 4 and the memory storage device 8 are enclosed within the main body 22. The positioning of the processing unit 4 and the memory storage device 8 allows the overall compact structure of the present invention to be maintained while also protecting the components from external impacts.

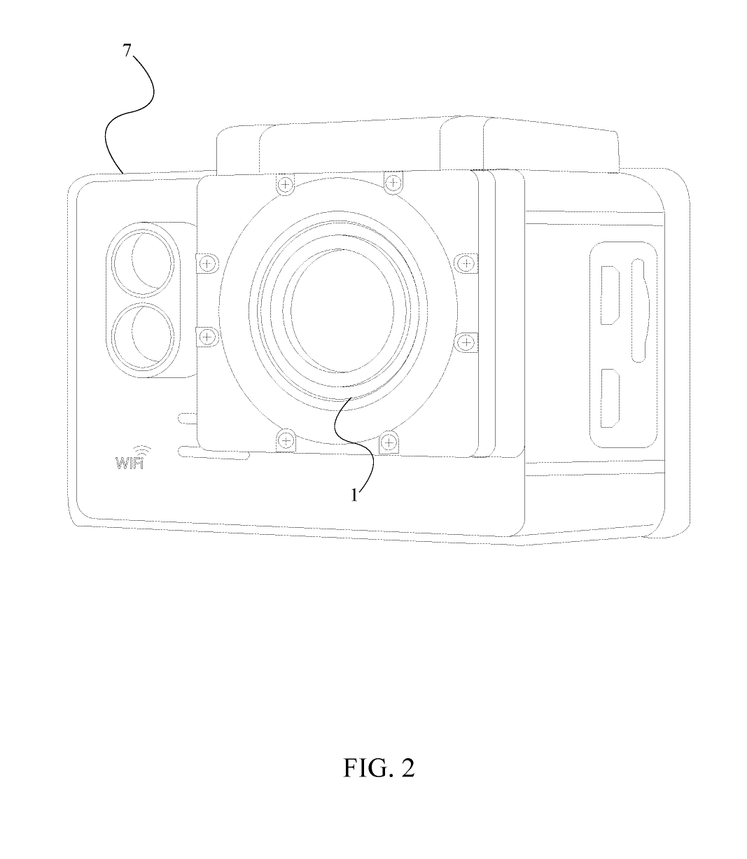

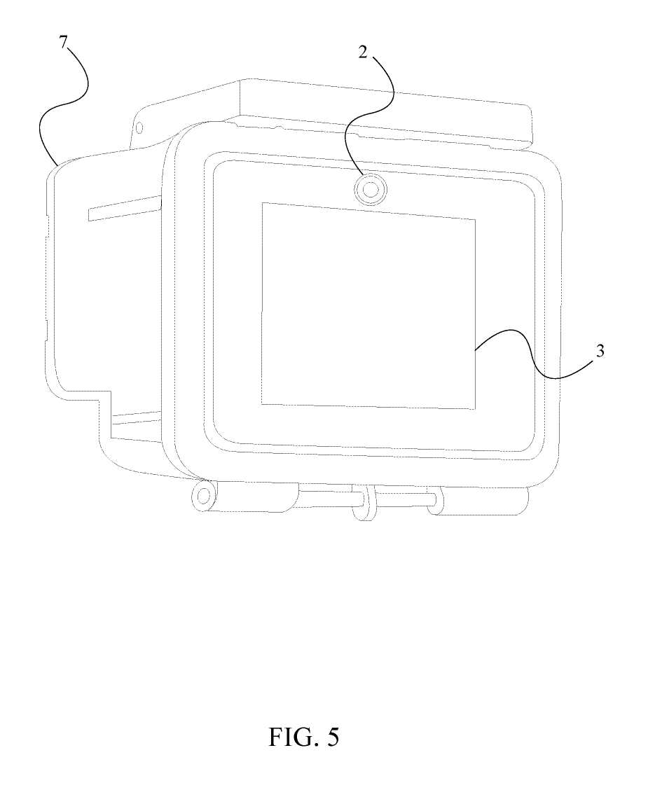

The present invention is mainly intended to be used outdoors. As seen in FIG. 2 and FIG. 5, the present invention comprises a waterproof housing 7 to protect the remainder of the components from hazardous environmental conditions. When the waterproof housing 7 is being used, the main body 22, the primary camera 1, the secondary camera 2, and the display screen 3 are positioned within the waterproof housing 7. Preferably, the waterproof housing 7 is made of a transparent material such that the functions of the primary camera 1, the secondary camera 2, and the display screen 3 are not hindered.

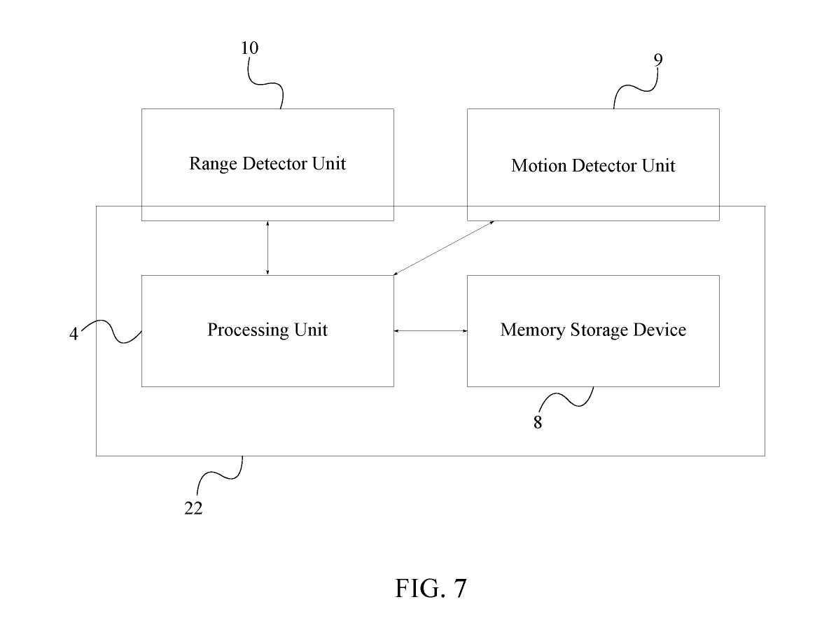

As experienced by many individuals, being aware of slight movements can be crucial during hunting. In order to notify the user regarding the slightest movements, the present invention comprises a motion detector unit 9 as seen in FIG. 7. The motion detector is electronically connected to the processing unit 4 and is positioned into the main body 22. Since the movements in front of the user needs to be observed, the motion detector unit 9 is positioned opposite the display screen 3 and adjacent the primary camera 1. Therefore, the motion detector unit 9 detects movements in front of the hunter. When the motion detector unit 9 is triggered with a movement, the user is notified. The user can be notified through the display screen 3 since the motion detector and the display screen 3 are both electronically connected to the processing unit 4. Even though one motion detector unit 9 is used in the preferred embodiment of the present invention, multiple motion detector units can be used in other embodiments of the present invention. As a result, the hunter is notified regarding movement in wide range.

Another disadvantage in hunting is not knowing the distance from the hunter to the target. The lack of knowledge is especially disadvantageous in bow hunting. In order to address the issue, the present invention comprises a range detector unit 10. In the preferred embodiment of the present invention, the range detector unit 10 comprises a laser beam transmitter 11. The range detector unit 10 is also positioned into the main body 22 and electronically connected to the processing unit 4. Similar to the motion detector unit 9, the range detector unit 10 is also positioned opposite the display screen 3. The positioning of the range detector unit 10 allows the user to receive notifications regarding the target through the display screen 3. The range detector unit 10 can be programmed such that a trigger from the motion detector unit 9 initiates the range determining process. As an example, if the motion detector unit 9 detects movement, the range detector unit 10 is notified such that the distance from the hunter to the target is measured. The area of movement and the distance to the area of movement are displayed on the displayed screen. When the distance is displayed, the hunter can determine if the target can be shot accurately or if any change in position is required.

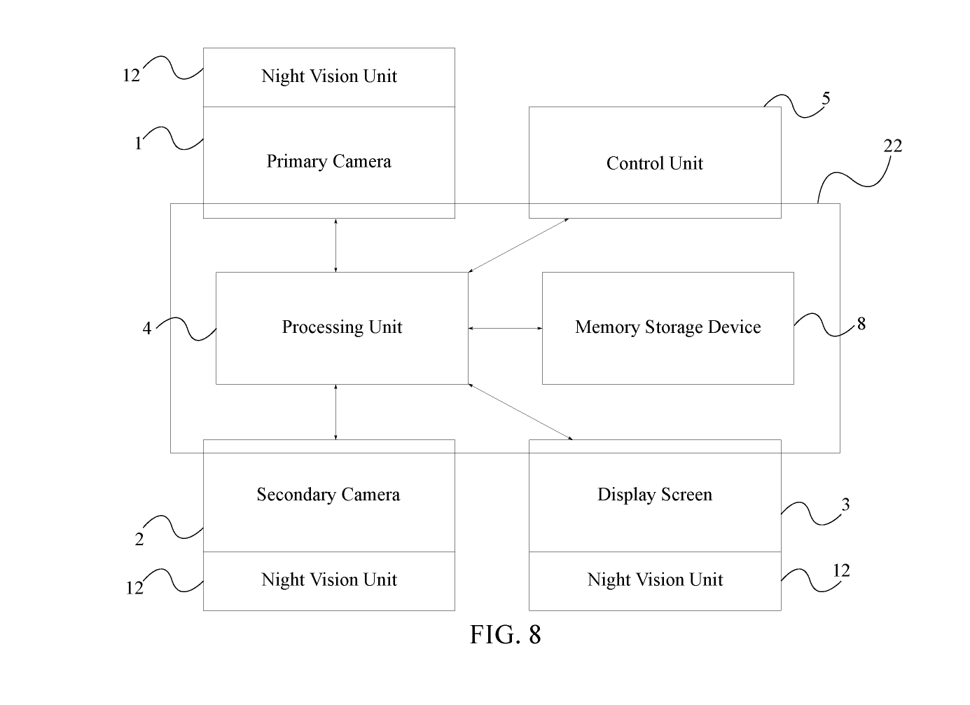

Limited visibility during low light conditions can be both disadvantageous and dangerous to the hunter. As seen in FIG. 8, the present invention comprises a night vision unit 12 which is integrated into both the primary camera 1 and the secondary camera 2. Therefore, the primary camera 1 and the secondary camera 2 can continue to capture data even in low light conditions. Moreover, the night vision unit 12 is also communicably coupled to the display screen 3. Therefore, the display screen 3 can display data received from the primary camera 1 with added brightness. The night vision unit 12 is electronically connected to the processing unit 4 allowing the user to control the night vision unit 12 as preferred.

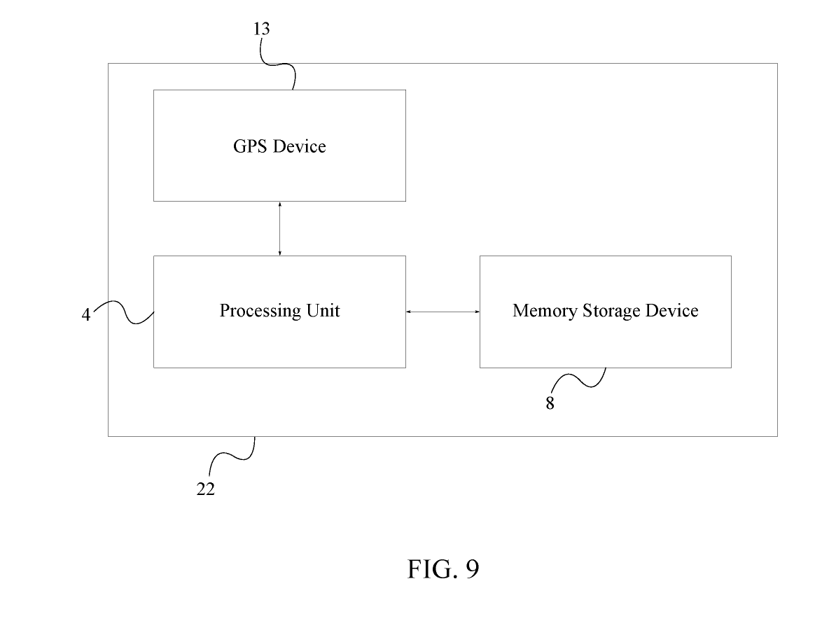

When hunting in challenging terrains, proper navigation is essential. The present invention comprises a global positioning system (GPS) device 13 for navigation purposes as shown in FIG. 9. The GPS device 13 is positioned within the main body 22 and is also electronically connected to the processing unit 4. The connection to the processing unit 4 allows the GPS device 13 to be programmed to display the navigation information on the display screen 3.

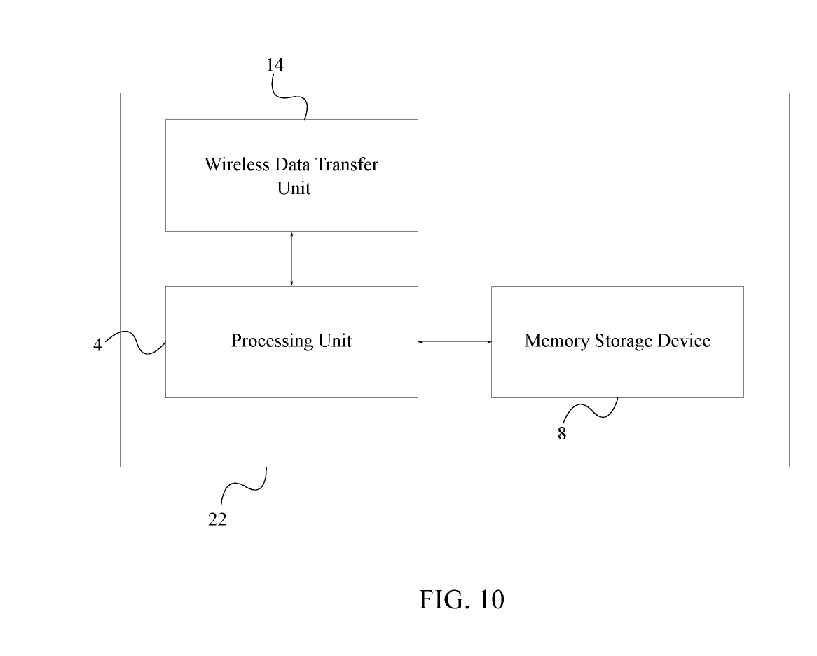

As shown in FIG. 10, the present invention further comprises a wireless data transfer unit 14 which is used to transfer data received from the primary camera 1 and the secondary camera 2 to an external storage device. In addition to transferring the data received from the primary camera 1 and the secondary camera 2, the wireless data transfer unit 14 can also be used to share navigation information and other related information. In order to do so, the wireless data transfer unit 14 is electronically connected to the processing unit 4 such that the transferrable data can be easily accessed via the processing unit 4. The wireless data transfer unit 14 is positioned within the main body 22 so that the overall shape of the present invention is not affected.

In addition to the wireless data transfer unit 14, the present invention further comprises a plurality of input/output ports 18. The plurality of input/output ports 18 can be used to feed and extract data from the present invention. In order to do so, the plurality of input/output ports 18 is electronically connected to the processing unit 4 and is positioned into the main body 22. As an example, the plurality of input/output ports 18 can be used to charge a power source 20 of the present invention through a cable or transfer data through a cable.

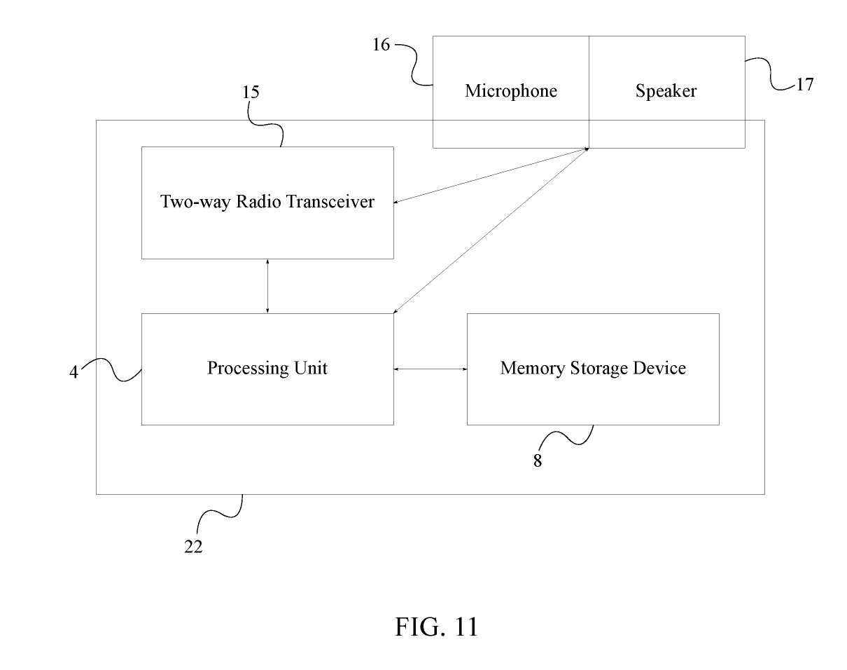

When a group of hunters are involved, having a clear line of communication with each of the hunters is essential. The present invention comprises a two-way radio transceiver 15 to fulfill the communication needs among the hunters of a group. The two-way radio transceiver 15 is electronically connected to the processing unit 4 and is positioned within the main body 22. The two-way radio transceiver 15 can vary in different embodiments of the present invention and can be, but is not limited to, a handheld transceiver. In order to receive and provide voice commands, the present invention further comprises a microphone 16 and a speaker 17 as illustrated in FIG. 11. In particular, the microphone 16 allows the user to provide commands while the speaker 17 allows the user to listen to voice commands. The speaker 17 can also be used to output audio data from the GPS device 13. In order to execute the necessary functions, the microphone 16 and the speaker 17 are electronically connected to the processing unit 4. Moreover, the microphone 16 and the speaker 17 is also electronically connected to the two-way radio transceiver 15 such that the user can receive and send commands to and from the two-way radio transceiver 15.

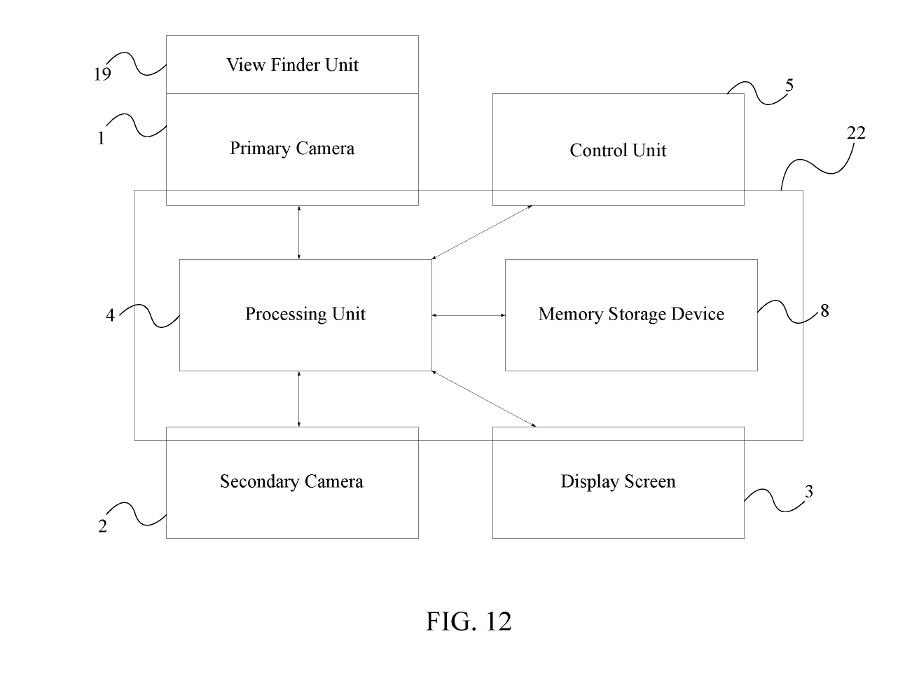

The present invention also provide means for improving shooting accuracy. In order to do so, the primary camera 1 comprises a view finder unit 19 as illustrated in FIG. 12. The view finder allows the user to position the target as preferred by observing the display screen 3. In order to do so, the view finder unit 19 is communicably coupled with the display screen 3. Moreover, the view finder unit 19 is electronically connected to the control unit 5 allowing the user to manage the view finder unit 19. The view finder unit 19 can be, but is not limited to, an archery sight.

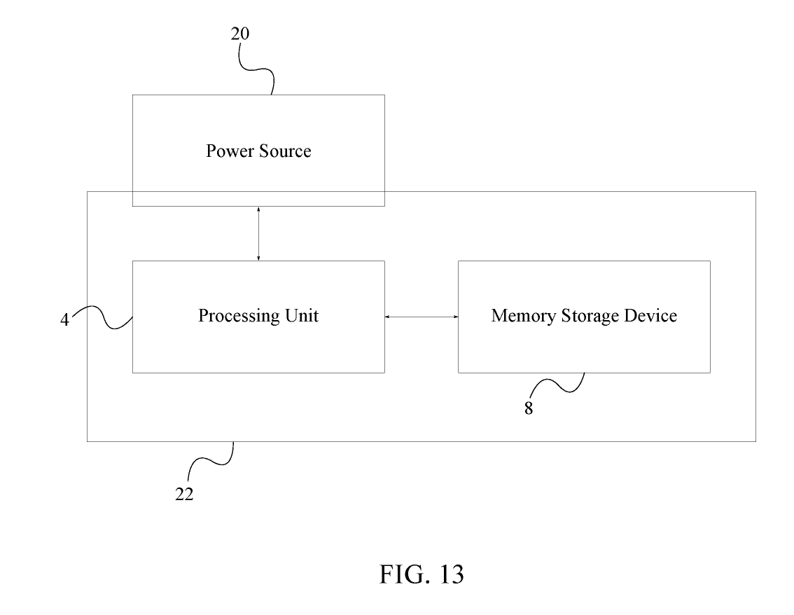

The present invention is powered through a power source 20. The power source 20 can be, but is not limited to, a battery. In order to provide power to the remainder of the components, the power source 20 is electronically connected to the processing unit 4 as in FIG. 13. For user convenience, the power source 20 is removably attached to the main body 22 such that the power source 20 can be replaced as preferred.

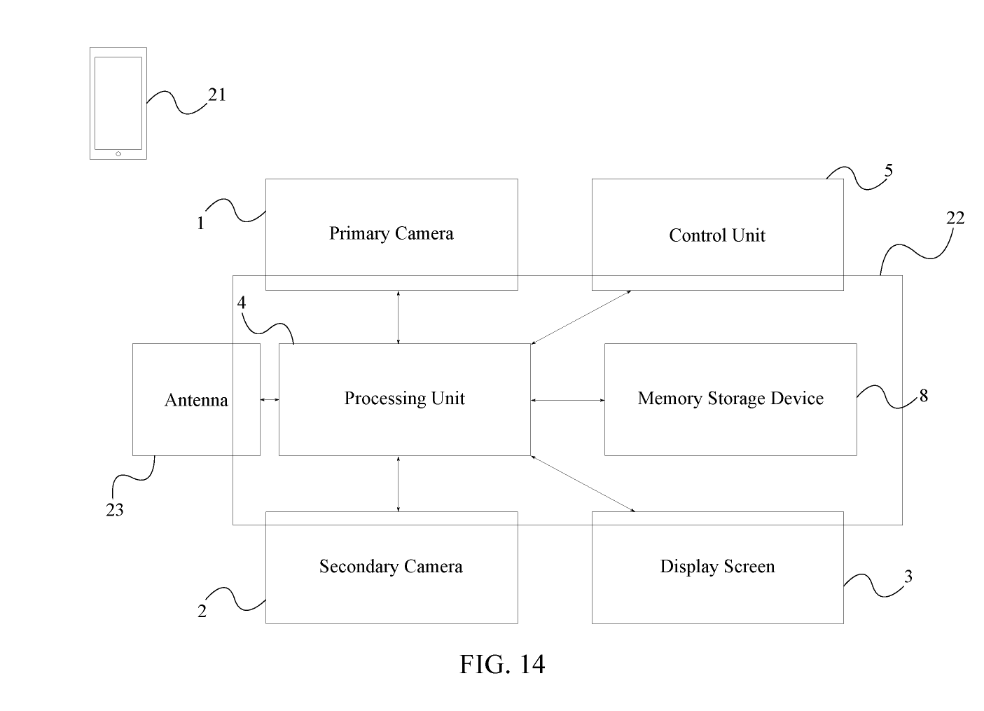

In order to provide user convenience, the present invention further comprises a remote control 21 and an antenna 23 as in FIG. 14. The antenna 23 is electronically connected to the processing unit 4 and extends from the main body 22 allowing the remote control 21 to access the processing unit 4. In other words, the remote control 21 is wirelessly connected to the control unit 5 via the antenna 23.

When utilizing the present invention, the following process flow can be followed. Since the present invention is used with a hunting device such as a gun or a bow, the present invention needs to be mounted onto the hunting device. In different embodiments of the present invention, varying mounting mechanisms can be used to mount the present invention onto the hunting device. When in use, the primary camera 1 is directed towards the target and the secondary camera 2 is directed towards the hunter. When the hunting process is initiated, the motion detector unit 9 notices any movement in the vicinity of the present invention and notifies the user through the display screen 3 or other comparable method. When notified, the range detector unit 10 measures the distance from the hunter to the target discovered by the motion detector unit 9. The calculated distance is then displayed on the display screen 3. Based on the displayed distance the hunter determines if the target can be accurately shot or not. If the hunter determines the target can be shot, the hunter then uses the view finder unit 19 to focus on the target and then ultimately shoot the target. If the need arises to hunt in low light conditions, the user utilizes the night vision unit 12. Moreover, if the need arises to navigate through the terrain the GPS device 13 is used. On the other hand, if the user needs to communicate with other users in the area, the two-way transceiver can be used.

Although the invention has been explained in relation to its preferred embodiment, it is to be understood that many other possible modifications and variations can be made without departing from the spirit and scope of the invention as hereinafter claimed.

What is claimed is:

1. A viewing device used in hunting comprises:
a primary camera;
a secondary camera;
a display screen;
a processing unit;
a control unit;
a memory storage device;
a main body;
the primary camera, the secondary camera, and the display screen being mounted into the main body;
the primary camera being positioned opposite the secondary camera across the main body;
the primary camera and the secondary camera being oriented in opposing directions;
the primary camera, the secondary camera, the control unit, the display screen, and the memory storage device being electronically connected to the processing unit;
the processing unit and the memory storage device being enclosed within the main body; and
the display screen being positioned opposite the primary camera across the main body.

2. The viewing device used in hunting as claimed in claim 1 further comprises:
a waterproof housing; and
the main body, the primary camera, the secondary camera, and the display screen being positioned within the waterproof housing.

3. The viewing device used in hunting as claimed in claim 1 further comprises:
a motion detector unit;
the motion detector unit being electronically connected to the processing unit;
the motion detector unit being positioned into the main body; and
the motion detector unit being positioned opposite the display screen.

4. The viewing device used in hunting as claimed in claim 1 further comprises:
a range detector unit;
the range detector unit being electronically connected to the processing unit;
the range detector unit being positioned into the main body; and
the range detector unit being positioned opposite the display screen.

5. The viewing device used in hunting as claimed in claim 4, wherein the range detector unit comprises a laser beam transmitter.

6. The viewing device used in hunting as claimed in claim 1 further comprises:
a night vision unit;
the night vision unit being integrated into the primary camera and the secondary camera;
the night vision unit being communicably coupled with the display screen; and
the night vision unit being electronically connected to the processing unit.

7. The viewing device used in hunting as claimed in claim 1 further comprises:
a global positioning system (GPS) device;
the GPS device being electronically connected to the processing unit; and
the GPS device being positioned within the main body.

8. The viewing device used in hunting as claimed in claim 1 further comprises:
a wireless data transfer unit;
the wireless data transfer unit being electronically connected to the processing unit; and
the wireless data transfer unit being positioned within the main body.

9. The viewing device used in hunting as claimed in claim 1 further comprises:
a two-way radio transceiver;
the two-way radio transceiver being electronically connected to the processing unit; and
the two-way radio transceiver being positioned within the main body.

10. The viewing device used in hunting as claimed in claim 1 further comprises:
a microphone;
a speaker;
the microphone and the speaker being positioned into the main body;
the microphone and the speaker being electronically connected to the processing unit; and
the microphone and the speaker being electronically connected to a two-way radio transceiver.

11. The viewing device used in hunting as claimed in claim 1 further comprises:
a plurality of input/output ports;
the plurality of input/output ports being electronically connected to the processing unit; and
the plurality of input/output ports positioned into the main body.

12. The viewing device used in hunting as claimed in claim 1, wherein the display screen is a touch-sensitive screen.

13. The viewing device used in hunting as claimed in claim 1 further comprises:
the primary camera comprises a view finder unit;
the view finder unit being electronically connected to the control unit; and
the view finder unit being communicably coupled with the display screen.

14. The viewing device used in hunting as claimed in claim 1 further comprises:
the control unit comprises a plurality of controls; and
the plurality of controls being integrated into the main body.

15. The viewing device used in hunting as claimed in claim 1 further comprises:
a power source; and
the power source being electrically connected to the processing unit.

16. The viewing device used in hunting as claimed in claim 15, wherein the power source is removably attached to the main body.

17. The viewing device used in hunting as claimed in claim 1 further comprises:
a remote control;
an antenna;
the antenna being electronically connected to the processing unit;
the antenna extending from the main body; and
the remote control being wirelessly connected to the control unit via the antenna.
